(19) United States
(12) Patent Application Publication
(10) Pub. No.: US 2025/0122058 A1
(43) Pub. Date: Apr. 17, 2025

(54) WAREHOUSE ROBOT AND METHOD FOR OPERATING A WAREHOUSE ROBOT

(71) Applicant: Cellgo Gmbh, Paderbom (DE)

(72) Inventors: Lukas PULS, Detmold (DE); Finn Buttgereit, Paderborn (DE)

(21) Appl. No.: 18/927,927

(22) Filed: Oct. 26, 2024

Related U.S. Application Data
(63) Continuation of application No. PCT/EP2023/082554, filed on Nov. 21, 2023.

(30) Foreign Application Priority Data
Nov. 22, 2022 (DE) 102022130831.6

(51) Int. Cl. B66F 9/065; B60G 17/00; B60P 1/02; B66F 9/06

(52) U.S. Cl. CPC B66F 9/065; B60G 17/00; B60P 1/027; B66F 9/063; B60G 2300/50; B60G 2500/30; B60G 2800/914

(57) ABSTRACT

A warehouse robot configured for automatically loading storage locations of a warehouse with containers, the warehouse robot including a plurality of electric motors; a horizontally oriented loading surface arranged at a topside of the warehouse robot and configured to receive a container of the containers; a plurality of motor rotatable wheels arranged at a bottom side of the warehouse robot and configured to move the warehouse robot on a ground, wherein rotation axes of the wheels are respectively oriented parallel to the loading surface, wherein first wheels of a first group of the wheels are synchronously oriented in a first driving direction, so that the warehouse robot is drivable in the first driving direction on the ground by motor driving the first wheels, wherein second wheels of a second group of the wheels are synchronously oriented in a second driving direction that differs from the first driving direction.

### RELATED APPLICATIONS

This application is a continuation of international application PCT/EP2023/082554 filed on Nov. 21, 2023 claiming priority from German patent application DE 10 2022 130 831.6 filed on Nov. 22, 2022, both of which are incorporated in their entirety by this reference.

### FIELD OF THE INVENTION

The invention relates to a warehouse robot and to a method for operating a warehouse robot.

The warehouse robot is configured to supply storage locations of a warehouse with containers autonomously. This includes storing the containers at or in the storage locations as well as retrieving the containers from the storage locations.

### BACKGROUND OF THE INVENTION

Generic warehouse robots are known in the art e.g. from international patent application WO 2022/043507 A 1. This application primarily relates to a warehouse that includes a travel plane and a storage plane vertically offset therefrom. The warehouse is assembled from a multitude of storage elements in a modular manner that facilitates travel of warehouse robots as well as storage of containers. The warehouse robot includes two groups of wheels which are transferrable between an active condition and a passive condition in an alternating manner. Thus the wheels of a first group are fixed at a housing of the warehouse robot and not vertically moveable relative to the housing. Only the wheels of the other group are vertically moveable and can thus be brought in contact with a ground alternating with the wheels of the first group and are thus transferrable between an active condition and a passive condition alternating with the other wheels. Additionally the warehouse robot can transition between a loading position and an unloading position using a lifting device, wherein the loading surface is vertically moveable using the lifting device so that an effective height of the warehouse robot is adjustable.

Another reference is US patent application 2014/0086714 A 1. This application also relates to a warehouse robot that includes two groups of wheels. Thus, the wheels of the first group are fixed at a housing so that they are not vertically moveable relative to the housing. Differently therefrom the wheels of the second group are vertically moveable relative to the housing so that the wheels of the two groups are transitionable between a passive condition and an active condition in an alternating manner by moving the moveable wheels. Furthermore, the warehouse robot includes a lifting device configured to adjust an effective height of the warehouse robot so that the warehouse robot is transitionable between a loading position and an unloading position.

It has proven detrimental for known robots to require a multitude of electric motors in order to perform the different movements of the wheels and of a respective lifting device. Additionally, the motors have to be sized to be able to apply considerably large lifting forces so that rather heavy containers can be lifted. The large space requirement of the motors makes designing the warehouse robots even more difficult in view of the fact that a particularly compact and light configuration is required.

Additional warehouse robots are known from the documents DE 10 2015 001 410 A 1 and CN 206088191 U.

### BRIEF SUMMARY OF THE INVENTION

It is an object of the instant invention to provide a warehouse robot with a design that is more efficient than prior designs.

The object is achieved by a warehouse robot configured for automatically loading storage locations of a warehouse with containers, the warehouse robot including a plurality of electric motors; a horizontally oriented loading surface arranged at a topside of the warehouse robot and configured to receive a container of the containers; a plurality of motor rotatable wheels arranged at a bottom side of the warehouse robot and configured to move the warehouse robot on a ground, wherein rotation axes of the wheels are respectively oriented parallel to the loading surface, wherein first wheels of a first group of the wheels are synchronously oriented in a first driving direction, so that the warehouse robot is drivable in the first driving direction on the ground by motor driving the first wheels, wherein second wheels of a second group of the wheels are synchronously oriented in a second driving direction that differs from the first driving direction so that the warehouse robot is drivable in the second driving direction on the ground by motor driving the second wheels, wherein the first wheels of the first group and the second wheels of the second group are transferable into a passive condition and into an active condition, wherein a distance measured orthogonal to the loading surface between rotation axes of the first wheels of the first group in their passive condition and the loading surface and between rotation axes of the second wheels of the second group in their passive condition and the loading surface is less than a distance measured orthogonal to the loading surface between the rotation axes of the first wheels of the first group in their active condition and the loading surface and between the second wheels of the second group in their active condition and the loading surface, wherein the warehouse robot is transferable between a retracted unloading position and an extended loading position in an alternating manner, wherein an effective height of the warehouse robot measured orthogonal to the loading surface is greater in the loading position, than in the unloading position, wherein the first wheels of the first group and the second wheels of the second group are motor movable in a direction orthogonal to the loading surface between a retracted position and at least one extended position, wherein a distance between a rotation axis of a respective first wheel of the first group and the loading surface measured orthogonal to the loading surface is greater for the respective first wheel of the first group in the extended position than for the respective first wheel of the first group in the retracted position, and a distance between a rotation axis of a respective second wheel of the second group and the loading surface measured orthogonal to the loading surface is greater for the respective second wheel of the second group in the extended position than for the respective second wheel of the second group in the retracted position, wherein the wheels of at least one of the first group and the second group are motor movable into at least two extended positions where distances of the rotation axes of the first wheels of the first group from the loading surface measured orthogonal to the loading surface differ from distances of the rotation axes of the second wheels of the second group from the loading surface measured orthogonal to the loading surface, wherein the warehouse robot is transitionable from a first extended position into a second extended position between its loading position and its unloading position by moving the first wheels of the first group or the second wheels of the second group, and wherein the warehouse robot is operable so that all of the first wheels of the first group and all the second wheels of the second group are simultaneously provided in their active position, so that the distance between the rotation axes of all the first wheels and second wheels and the loading surface is identical for all the first wheels of the first group and all the second wheels of the second group.

Advantageous embodiments can be derived from the dependent claims and the description.

The warehouse robot includes a plurality of electric motors. The electric motors are configured in particular to drive the wheels of the warehouse robot to rotate so that the warehouse robot can move on a ground. Additionally, at least some of the motors can be configured to cause an elevation adjustment of at least some of the wheels wherein the respective wheels are vertically moveable by the respective motors. This can be a pivot movement in particular as separately described infra and is also shown in the embodiments.

The warehouse robot includes a horizontally oriented loading surface at a topside of the warehouse robot configured to receive at least one container. The loading surface is advantageously flat, however, individual elements, e.g. form locking elements can vertically protrude upward beyond the loading surface.

The warehouse robot includes a plurality of wheels drivable by motors to rotate and arranged at a bottom side of the warehouse robot and configured to move the warehouse robot on the ground. The rotation axes of the wheels are respectively oriented parallel to the loading surface. This renders the warehouse robot moveable in a plane that is oriented parallel to the loading surface. This way the loading surface is not inclined when the warehouse robot moves over the ground, so that a container that is positioned on the loading surface is continuously supported on a horizontal loading surface.

The wheels of the warehouse robot are divided into at least two groups of wheels, typically exactly into two groups of wheels. The groups of wheels differ in an orientation of their respectively associated wheels. Thus, all wheels of the first group are oriented in a first driving direction so that the warehouse robot is drivable in the first driving direction by motors driving these wheels. Accordingly all the wheels of a second group are also oriented in a driving direction, wherein the second driving direction differs from the first driving direction. Typically, the second driving direction is oriented perpendicular to the first driving direction. The orientation of the wheels is defined by the orientation of the rotating axes of the wheels, wherein the respective driving direction is oriented perpendicular to the rotation axes of the respective wheels. Since the rotation axes of the wheels are oriented parallel to the loading surface a warehouse robot thus configured is movable by the wheels of the two groups in two driving directions that are linear independent in a plane defined by the rotation axes of the wheels, advantageously the warehouse robot is movable in two driving directions that are oriented perpendicular. The plane defined by the wheel axes is parallel to the loading surface. When the loading surface has a rectangular shape the two driving directions can be oriented to coincide with the two main axes of the rectangular loading surface. Advantageously, at least all wheels of one of the two groups, advantageously all wheels of the warehouse robot have an identical wheel diameter. Put differently, all wheels of the warehouse robot are identical.

The wheels of the two groups can be transitioned from a passive condition into an active condition. The passive condition and the active condition differ through a distance between the rotation axes of the respective wheels and the loading surface measured orthogonal to the loading surface. Thus, a distance of rotation axes of wheels that are in a passive condition measured perpendicular to the loading surface is less than a distance of rotation axes of the wheels that are in the active condition measure from the loading surface.

Therefore, the wheels that are in the active condition are in contact with the ground, whereas the wheels that are in the passive condition are not in contact with the ground. The differentiation between the passive condition and the active condition is therefore determined by a position of the wheels relative to each other. Thus, the wheels that are further remote from the loading surface are active, whereas the other wheels that are proximal to the loading surface are passive. As a matter of principle the wheels in the passive condition cannot be in contact with the respective ground, however, the wheels in the active condition are in contact with the ground. Put differently, the wheels that are in the active condition determine a driving direction in which the warehouse robot is drivable on the ground.

Additionally, all wheels can be provided in their active condition simultaneously, this means the described distance between the rotation axes of the wheels and the loading surface is identical for all wheels. In this condition all wheels are in contact with the ground simultaneously. This can be the case e.g. when all wheels of the warehouse robot are in an identical extension position when the driving direction of the robot changes or for lifting heavy containers.

The warehouse robot is also configured to be transferrable between a retracted unloading position and an extended loading condition alternatively. The two positions differ in that an effective height of the warehouse robot measured perpendicular to the loading surface is greater in the loading position of the warehouse robot than in an unloading position of the warehouse robot. In the unloading position where the effective height of the warehouse robot is rather small the warehouse robot is configured to drive in a travel plane of the warehouse and to move below containers that are stored in the storage plane of the warehouse without the warehouse robot colliding with the containers. The storage plane is arranged vertically above the travel plane wherein a vertically measured distance of the storage plane from the travel plane is greater than the effective height of the warehouse robot when the warehouse robot is in its unloading position. The warehouse robot can be positioned below a container to retrieve the container from a storage location of the warehouse and then the warehouse robot can be transitioned from its unloading position into its loading position which increases the effective height of the warehouse robot. Thus the warehouse robot contacts the container from below and lifts the container from its storage location upon further increase of an effective height of the warehouse robot. Thereafter the container is stored on the storage surface of the warehouse robot, so that the warehouse robot can transport the container.

The warehouse robot is configured so that the wheels are movable between a retracted position and at least one extended position motor driven in a direction perpendicular to the loading surface. The retracted position and the extended position differ in that a distance measured perpendicular to the loading surface between the rotation axis of a respective wheel and the loading surface is greater for the wheel in the extended position, than in the retracted position.

According to the invention the wheels of at least one of the groups, advantageously all wheels are movable motor driven into at least two extended positions, namely at least a first extended position and a second extended position where distances of the rotation axes of these wheels from the loading surface differ from each other wherein the distance is measured perpendicular to the loading surface. The wheels that are movable into at least two extended positions are thus movable into at least three different positions, namely the retracted position and two different extended positions. Advantageously the wheels are movable into precisely two extended positions and operable in these extended positions. The movement of the wheels is thus implemented so that the wheels can remain in the different extended positions. Thus, not every position of the wheel that is passed when the wheel moves perpendicular to the loading surface of the warehouse robot is not an extended position according to the invention. An extended position is only provided when the respective wheel remains in the respective position or can remain in the respective position and the warehouse robot can travel in the travel plane of the warehouse when the wheels are in the respective extended position. Typically, the wheels that are in the extended position are provided in their active condition. Wheels that are provided in their passive condition are respectively arranged in their retracted position. However, the wheels of one of the groups can be provided in their second further extended position in their active condition in contact with the ground and the wheels of the other groups can be respectively provided in the first extended position that is further retracted compared to the second extended position and can therefore be provided in their passive condition without contact with the ground.

The movement of the wheels that are movable into two different extended positions in addition to the retracted position cause a transition of the warehouse robot between its loading position and its unloading position due to this movement. Thus, the warehouse robot is transferrable from the first extended position into the second extended position between its loading position and its unloading positions by moving the wheels, wherein the effective height of the warehouse robot is increased from a first elevation level to a second elevation level while adjusting the extension position. Accordingly the distance between the rotation axes of the wheels and the loading surface is greater when the wheels are in the second extended position, than when the wheels are in the first extended position. Advantageously the rotation axes of the wheels of the warehouse robot are continuously oriented horizontally independently from their position, retracted position, or extended position, and parallel to the loading surface of the warehouse robot. The orientation of the rotation axes of the wheels is therefore advantageously unchanged by an adjustment of the position of the wheels relative to the loading surface.

The warehouse robot according to the invention has many advantages. The core idea is transitioning between the loading position and the unloading position and alternatively transferring the wheels into their active condition or their passive condition can be performed by the same electric motors. Thus, the wheels of at least one group, advantageously the wheels of all groups can be moved from the retracted position into a first extended position by an electric motor wherein the wheels are in their active condition in the extended position. This can be the case in particular when the wheels of the other group are in their retracted position. The first extended position is selected so that the effective height of the warehouse robot is smaller than a vertical distance of the storage plane of the respective warehouse from the travel plane of the warehouse. Accordingly, the warehouse robot is in its unloading position where its effective height is sized to that the warehouse robot can move in the warehouse in the travel plane without colliding with containers that are stored in the storage plane arranged above the travel plane. Put differently, the warehouse robot can travel below the containers in the unloading position of the warehouse robot.

A distance of the loading surface from the rotation axes of the wheels increases when transitioning the respective wheels from the first extension position into the second extension position. Put differently, the wheels are extended further. Since the wheels are already in contact with the ground the increase of the distance between the rotation axes and the loading surface can only be implemented in that the loading surface is raised. Thus, the warehouse robot is transitioned into its loading position wherein the effective height of the warehouse robot increases. This can be used for operating the warehouse to increase the height of the warehouse robot to an amount that exceeds the distance of the storage plane from the travel plan of the warehouse, so that the container is lifted from its storage location by the warehouse robot. Thereafter the warehouse robot is loaded with the container on the loading surface of the warehouse robot. Thus, the warehouse robot can travel with the container stored thereon along a travel path of the warehouse, wherein the warehouse robot is limited to a travel path that does not have any containers stored thereon as a matter of principle.

As a difference over the prior art a separate lifting device for raising the loading surface, e.g. a lifting device driven by separate electric motors is not required. Instead, the motors that are required anyhow for moving the wheels perpendicular to the loading surface between the retracted position and the extended positions in order to bring the wheels of both groups in contact with the ground alternatively, this means transitioning them between their active condition and their passive condition alternatively so that the robot can drive in the respective driving directions, are used in a double function to efficiently adjust the height of the warehouse robot and thus to switch the warehouse robot between its unloading position and its loading position. Advantageously each wheel cooperates with a proper motor that is configured to implement the described vertical movement of the respectively associated wheel.

Advantageously all wheels of the warehouse robot can be moved into at least two different extended positions in addition to the retracted position, advantageously exactly two different extended positions. This has the particular advantage that moving the warehouse robot from its unloading position into its loading position can be jointly accomplished by all wheels or motors that cooperate with the wheels. Advantageously a proper motor is provided for moving the wheels between the retracted position and the extended position so that combining all wheels, torques provided by the motors can be combined so that a resulting lifting force applicable by the warehouse robot to lift a container from its storage location is greater than using only the wheels of one group for transitioning the warehouse robot into its loading position. This facilitates lifting containers with comparatively large mass, wherein the individual motors can be provided with comparatively low power and thus a comparatively small installed volume.

This means for operating the warehouse robot that the warehouse robot is initially positioned below a container. For this purpose the wheels of a group are in an active condition and the wheels of another group are in their passive condition. Since the warehouse robot is in its unloading position where it can travel below the containers the wheels that are in its active condition are provided in their first extended position. The wheels of the other group are still in their retracted position. Now the container arranged above the warehouse robot is to be lifted from its storage location. Since the container has a rather large mass the motors that move the wheels between their retracted position and their two extended positions shall be combined with one another in order to jointly lift the loading surface and the container stored thereon. Accordingly the wheels of the group that were in their retracted position are moved into their first extended position. Thereafter the wheels of all groups are simultaneously arranged in their first extended position and in contact with the ground and thus in their active condition.

Thereafter the wheels of all groups are jointly thus synchronously moved into their second extended position by their respective motors, so that the loading surface is raised and the warehouse robot is transitioned into its loading position. Thus the torques of all motors act in combination so that the motors are able to jointly lift the container. When the warehouse robot has a total of eight wheels divided in two groups lifting the container is performed using the described operating mode with a total of eight motors. In addition to combining the torques of all motors another advantage is provided in that the warehouse robot sits on the ground in a stable manner and does not move when transitioning from the unloading position into the loading position, this means when the receiving a respective container. This is caused by the fact that the wheels of the different groups are in contact with the ground simultaneously and therefore mutually prevent a rotation movement. This effect can also be supported by a configuration of the travel plane of the warehouse. Advantageously the warehouse includes guide elements in a travel plane that prevent a lateral movement of the wheels, this means in a direction of the rotation axis of the respective wheel.

When all wheels are in contact with the ground (active condition) and are guided by the guide elements in the travel plane the warehouse robot is in positive form locking connection with the warehouse through its wheels wherein the positive form locking connection prevents a movement parallel to the travel plane, in particular in both driving directions. No additional braking of at least a portion of the wheels is required for stabilizing the position of the warehouse robot when receiving a container.

After the container has been received on the loading surface only the wheels of one group are left in their active condition and in their second extended position while all remaining wheels are retracted again, this means put into their passive condition. Moving the wheels into their passive condition can include a movement back into the retracted position as well as into the first extended position. In any case only the wheels of one group are in their active condition and thus in contact with the ground so that the warehouse robot is drivable on the ground in the driving direction by causing these wheels to rotate.

The configuration where all wheels of the warehouse robot are movable into at least two extended position, advantageously exactly two extended positions, has an additional advantage in that changing the driving direction of the robot is possible without changing the effective height of the warehouse robot. This will be described infra with reference to the method according to the invention.

It is furthermore advantageous when the rotation axes of all wheels are arranged in a common retraction plane when they are in their respective retracted position. This configuration facilitates providing the warehouse robot particularly flat overall which provides a minimum effective height of the warehouse robot when all wheels of all groups are in their retracted position simultaneously. When the rotation axes of all wheels are arranged in the retraction plane simultaneously the warehouse robot is typically not drivable on the ground. This can be caused by the fact that the wheels are not in contact with the ground. If the wheels are in contact with the ground differently oriented wheels block each other. In order to establish drivability of the warehouse robot the wheels of one of the groups have to be moved relative to the loading surface into one of the extended positions so that only the wheels of this group are in contact with the ground that are oriented in an identical driving direction.

Arranging the wheels of all groups so that they are arranged in a common retraction plane when arranged in their retracted position has the additional advantage that the warehouse robot can be configured overall from a maximum number of identical parts or modules. In particular each wheel can be jointly connected with an associated motor to form an operating unit as will be described infra.

In analogy to the description provided supra it can be particularly advantageous to arrange the rotation axes of all wheels in a common first extension plane when the wheels are respectively arranged in their first extended position. When all wheels are movable into different extension positions it is advantageous when the rotation axes of all wheels are arranged in a common second extension plane when the wheels are respectively provided in their second extension position. As described supra the distance between the first extension plane and the loading surface is smaller than the distance between the second extension plane and the loading surface.

In an advantageous embodiment at least one wheel of one group, further advantageously all wheels of the warehouse robot respectively form a part of the operating unit. In addition to the respective wheel the operating unit includes a lift motor configured to lift the wheel between a retracted position and at least one extended position and a drive motor configured to drive the wheel to rotate above its rotation axis. This embodiment has the particular advantageous that the functions “propulsion” and “elevation adjustment” of the warehouse robot at the respective wheels are implemented by different motors which can be configured and sized for their respective purpose. Thus it is required in particular for the elevation adjustment, in particular transitioning the warehouse robot between its loading position and its unloading position that lifting forces of a certain size can be applied in order to lift even heavy containers from their respective storage location. The lift motor can be specifically configured for this task. There are different requirements for the rotation drive of the wheels. Thus the focus is to be able to accelerate the robot swiftly during operations and move it along its travel path with a predetermined speed. Thus, it is advantageous when the drive motor cooperates with a transmission which can also be part of the operating unit. In this embodiment the drive motor can be adapted to the transmission so that optimum drive operations of the warehouse robot can be achieved.

Combining a respective wheel with the lift motor and the drive motor is also advantageous with respect to ease of maintenance. In case there is a mechanical defect during operation of the warehouse robot it is essential to be able to repair the defect swiftly in order to minimize downtime of the respective warehouse robot. Thus, an operating unit which is potentially defective can be replaced in a quick and simple manner in its entirety in field operations so that the warehouse robot can resume operations after a short downtime. The drive unit can be checked separately and may be repaired without having to shut down the warehouse robot.

Additionally, a configuration of the warehouse robot can be advantageous where the wheels of at least one group, advantageously the wheels of all groups are respectively supported at a pivot arm. The pivot arm is directly or indirectly supported at a housing of the warehouse robot about a pivot axis. The pivot arm may be connected at the housing with the pivot axis arranged at a first end of the pivot arm, whereas the respective wheel is supported at an opposite end of the pivot arm. The pivot arm can cooperate e.g. with a motor, in particular a dedicated lift motor by which the pivot arm is pivotable about the pivot axis relative to the housing so that a wheel supported at the pivot arm moves about the pivot axis on a circular path. The orientation of the pivot arm is provided so that pivoting the pivot arm about the pivot axis causes a movement of the wheel that has a component in a direction perpendicular to the loading surface of the warehouse robot. This way the wheel can be moved perpendicular to the loading surface by pivoting the pivot arm and the wheel is transferrable from an active condition into a passive condition between its retracted position and at least one extended position, advantageously plural extended positions. The pivot arm can be straight or curved.

When the warehouse robot includes the pivot arms described supra it can be advantageous when a pivot axis of a pivot arm associated with a respective wheel is oriented
parallel to the loading surface when the wheel is in its retracted position, and/or
at an angle between 20 degrees and 70 degrees, advantageously at an angle between 50 degrees and 70 degrees, further advantageously at an angle of 60 degrees relative to the loading surface and/or at an angle of 80 degrees to 100 degrees, advantageously at an angle between 90 degrees and 100 degrees relative to the loading surface.

For an intrinsically straight pivot arm the component axis is identical with a longitudinal axis of the pivot arm. When the pivot arm is curved or provided with an elbow the component axis runs in a straight line from the pivot axis of the pivot arm to the rotation axis of a wheel supported at the pivot arm.

The orientation of the pivot arm parallel to the loading surface when the associated wheel is in the retracted position has the advantage that the effective height of the warehouse robot can be reduced to a minimum. Vice versa, the effective height of the warehouse robot is at a maximum when the pivot arm is deflected downward from a horizontal position, this means from a position parallel to the loading surface by substantially 90 degrees, so that the component axis of the pivot arm is oriented perpendicular to the loading surface. When the wheels of a group are in the second extended position it is not necessarily advantageous for the operation of the warehouse robot to move the pivot arm in this position, this means orient the pivot arm perpendicular to the loading surface since this is an instable position where the pivot arm can pivot in one or another direction under a load. In order to have a defined load impact upon the pivot arm it is advantageous when an angle between the component axis of the pivot arm and the loading surface is greater than 90 degrees or less than 90 degrees when the associated wheel is in the second extended position. In order to reach a maximum effective height of the warehouse robot in the second extended position a range between 80 degrees and 100 degrees is advantageous for the extension angle.

Advantageously the angle between the component axis of a respective pivot arm and the loading surface is more than 90 degrees, wherein the pivot arm hits a stop. This has the advantage that the pivot arms are supported at the stop intrinsically stable when the respective wheels are provided in their second extension position. Thus, the position of the pivot arms remain stable without providing current to the respectively associated lift motors. The angle between the component axis and the loading surface can be between 91 degrees and 95 degrees, advantageously at 93 degrees when contacting a respective stop.

When the warehouse robot is provided with one respective pivot arm per wheel it is advantageous when a respective lift motor associated with the respective pivot arm is directly or indirectly supported at the housing so that the pivot arm is pivotable about the pivot axis relative to the housing by the lift motor. In this embodiment the lift motor is advantageously supported at the pivot arm so that the drive motor is movable on a circular path about the pivot axis when transitioning the wheel between its retracted position and at least one extended position. Put differently, the drive motor is associated with the wheel which is also supported at the pivot arm and movable about the pivot axis on a circular path as described supra. In this embodiment the operating unit described supra can be formed in a particularly simple manner, wherein the operating unit respectively incudes a lift motor, a pivot arm, a drive motor, optionally a transmission cooperating with the drive motor, and a wheel.

The object is achieved by the method comprising:
a) driving the warehouse robot in the unloading position over a ground by motor driving the wheels of one of the groups and stopping the warehouse robot at a storage location loaded with a container so that the warehouse robot is stopped under the container;
b) moving the wheels of at least one group into an extended position by motor after stopping the warehouse robot below the container, so that the warehouse robot is transitioned from its unloading position into its loading position and retrieves the container from the storage location so that the container is supported on the loading surface of the warehouse robot thereafter;
c) driving the warehouse robot over the ground together with the container supported on the loading surface after receiving the container, wherein the driving is performed by motor driving the wheels of one of the groups; and
d) moving the wheels of the group whose wheels where in the passive condition by a motor into an extended position in which the wheels of both groups are in contact with the ground simultaneously in order to change the driving direction, wherein the wheels of the other group whose wheels were in their active condition are moved towards their retracted position and thus into their passive condition.

Advantageous embodiments of the invention can be derived from the associated dependent claims.

The method includes the steps: initially driving the warehouse robot over a ground by motor driving the wheels of a group to rotate and stopping the warehouse robot at a storage location loaded with a container below the container. Thus, the warehouse robot is provided in its unloading position where its effective height undercuts a vertical distance between a container and the ground or between the storage plane and the travel plane of the warehouse. This way the warehouse robot can drive under the container without colliding with the container. The rotation driven wheels are in their active condition and in contact with the ground The wheels of the other group are in their passive condition.

Thereafter the wheels of at least one group are motor driven into an extended position where the effective height of the warehouse robot exceeds the distance between the container and the ground described supra. Put differently this means that the warehouse robot is moved from an unloading position into a loading position wherein the container is lifted from its storage location due to the lifting of the loading surface. Consequently, the container is supported on the loading surface of the warehouse robot. The wheels of the respective group can be transitioned from the first extended position into a second extended position wherein the warehouse robot is in its unloading position when the wheels are in the first extended position and the warehouse robot is in it loading position when the wheels are in their second extended position.

After receiving the container on the loading surface the warehouse robot including the container supported on the loading surface drives over the ground through the motor driven rotation of the wheels of one of the groups.

The method according to the invention is executable in a particularly simple manner by the warehouse robot according to the invention. The resulting advantages have already been described supra. In particular, the respective container can be lifted by the same motors that transfer the wheels of the different groups respectively between their retracted position and at least one extended position. Providing an additional lifting device for raising the loading surface as used in the prior art can be omitted. Thus, it is advantageous when the wheels of all groups or all wheels of the warehouse robot are transferrable into at least two extended positions, advantageously into exactly two extended positions in addition to the retracted position.

In order to change a driving direction of the warehouse robot according to the invention wheels of the group whose wheels were in the passive condition are moved into an extended position motor driven where the wheels of the group are in contact with the ground coinciding with the wheels of one of the groups whose wheels have been in the active condition so far. The warehouse robot may include two groups of wheels, one group for driving in a first driving direction and a second group for driving in a second driving direction that differs from the first driving direction, wherein the second driving direction may be perpendicular to the first driving direction. When the warehouse robot only includes two different groups of wheels all wheels of the warehouse robot are in contact with the ground simultaneously. Put differently, the distances of the rotation axes of all wheels from the loading surface measured perpendicular to the loading surface are identical. Consequently all wheels of the warehouse robot are provided in the active condition. Then, the wheels of the groups that have been in the active condition before are moved towards their retracted position, advantageously into their retracted position and thus into their passive condition. Consequently, only those wheels are in their active condition that were previously moved into their respective extended position. Since these wheels are part of a common group and therefore oriented in a common driving direction the warehouse robot can thus drive on the ground propelled by the rotation drive of these wheels. This driving direction differs from the driving direction in which the warehouse robot was movable or moved when the wheels of the other group were in their active condition which now are in their passive condition.

It is a particular advantage of this type of driving direction change that the warehouse robot cannot move during the driving direction change so that its position is known precisely at any point in time. This is due to the fact that the wheels of different groups, advantageously all wheels of the warehouse robot, are in contact with the ground jointly, this means in their active condition when transitioning from one driving direction to another driving direction. Therefore, the wheels block each other during driving direction change, optionally in cooperation with guide elements of the warehouse as described supra already with reference to lifting containers. It is furthermore particularly advantageous that the loading surface, possibly with a container supported thereon, remains at an identical elevation during a driving direction change and is therefore not moved in the vertical direction. This way no mechanical work is performed during the driving direction change which improves energy efficiency of the warehouse robot.

When the driving direction change is performed in the manner described supra it can be particularly advantageous when the driving direction change is performed in the same manner when the warehouse robot is in the unloading position and in the loading position. The only difference is in the extension positions. In particular, the wheels can be provided in the first extension position, thus the unloading position of the warehouse robot, or in the further extended second extension position, thus the loading position of the warehouse robot during the driving direction change. The first position is typically selected when the warehouse robot is unloaded during the driving direction change, the second position is typically selected when the warehouse robot is loaded during the driving direction change.

In a particularly advantageous embodiment of the method the wheels of all groups are initially moved into a common first extension position in order to transition the warehouse robot from its unloading position into its loading position. Thereafter all wheels are moved synchronously into a second extension position that is extended further relative to the first extension position, so that the warehouse robot is transitioned from its unloading position into its loading position. Since all wheels are in contact with the ground during the process this operating mode facilitates lifting a respective container from its respective storage location by the combined torques of all motors which transfer the wheels of all groups between their retracted position and their extended positions as described supra. Thus, the torques of the motors are combined with one another so that each individual motor is loaded less and can be sized smaller. In spite of these smaller motor size the total imparted lifting force is sufficient to lift a greater mass container from its storage location. After receiving a respective container from its storage location the wheels of the groups are retracted again which are not provided for propelling the warehouse robot immediately after receiving the container, thus the wheels are transitioned into their passive conditions. Put differently, only those wheels remain in their second extension position and thus in their active condition in contact with the ground that are oriented in the driving direction in which the warehouse robot shall drive after receiving the container.

### BRIEF DESCRIPTION OF THE DRAWINGS

The invention will be subsequently described based on an embodiment with reference to drawing figures, wherein:

FIG. 1 illustrates a side view of a warehouse robot according to the invention in a loading position;

FIG. 2 illustrates an isometric view of the warehouse robot according to FIG. 1 in the loading position;

FIG. 3 illustrates a schematic side view of the warehouse robot according to FIG. 1 in the loading position;

FIG. 4 illustrates the side view according to FIG. 3 showing the warehouse robot in its unloading position;

FIG. 5 illustrates an isometric view of the warehouse robot according to FIG. 1 in its unloading position;

FIG. 6 illustrates the isometric view of the warehouse robot according to FIG. 5 in its loading position;

FIG. 7 illustrates a view of a bottom side of the warehouse robot according to FIG. 1;

FIG. 8 illustrates a detail of two operating units of the warehouse robot according to FIG. 1; and

FIG. 9 illustrates an operating unit of the warehouse robot according to FIG. 1.

### DETAILED DESCRIPTION

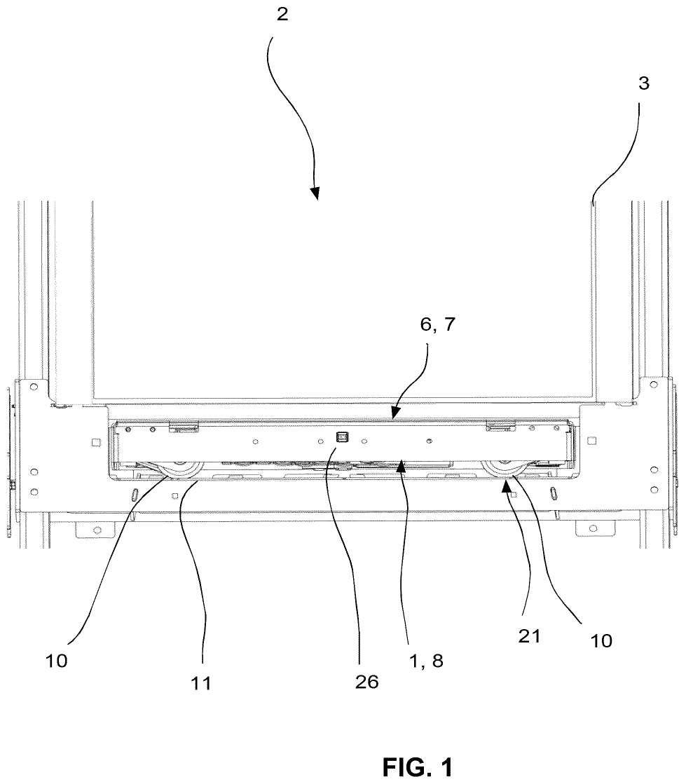

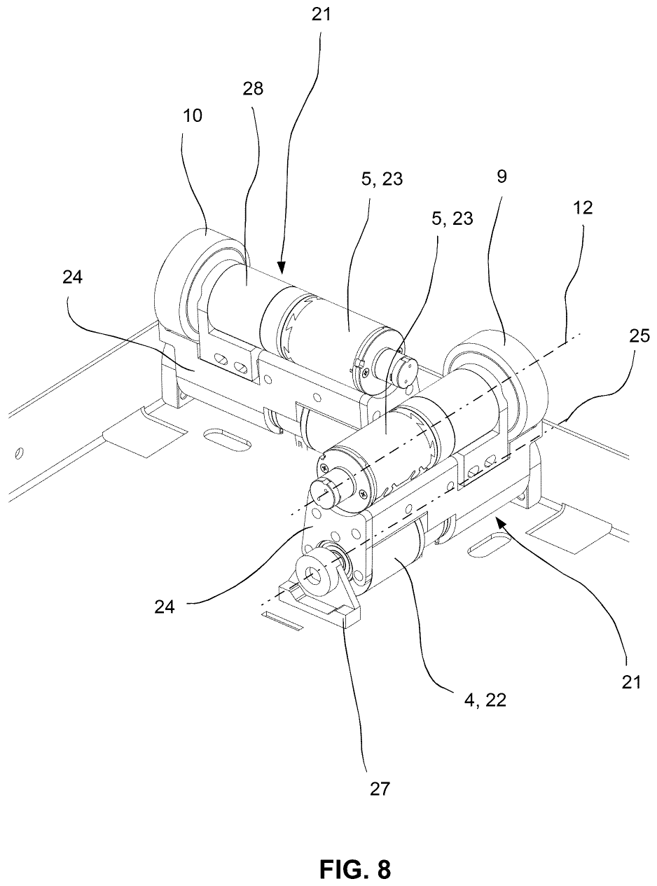

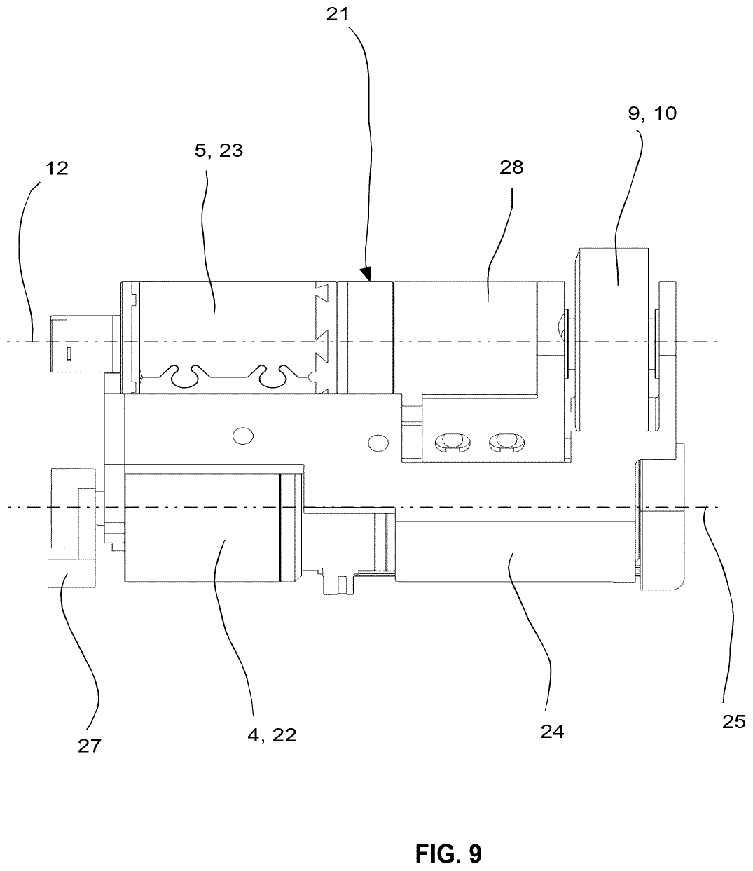

An embodiment illustrated in FIGS. 1-9 includes a warehouse robot 1 configured to drive in a warehouse and to retrieve containers 3 from respective storage locations 2 of the warehouse and deposit the containers at the storage locations 2. The warehouse robot 1 includes a total of eight wheels 9, 10 in the illustrated embodiment, so that the warehouse robot 1 is drivable on the ground 11 by the wheels. In order to move the wheels 9, 10 the warehouse robot 1 includes a plurality of motors 4, 5 configured as electric motors in the illustrated embodiment. The wheels 9, 10 are respectively arranged at a bottom side 8 of the housing 26 of the warehouse robot 1. A loading surface 7 is configured at a topside 6 of the housing of the warehouse robot 1. The loading surface 7 is flat so that a container 3 supported on the loading surface 7 is oriented horizontally.

The wheels 9, 10 respectively include a rotation axis 12, and are drivable to rotate by at least some of the motors 4, 5. The wheels 9, 10 are arranged in the illustrated embodiment so that their rotation axis 12 are arranged in a common retraction plane 18 that is oriented parallel to the loading surface 7 when the wheels 9, 10 are respectively arranged in their retracted position.

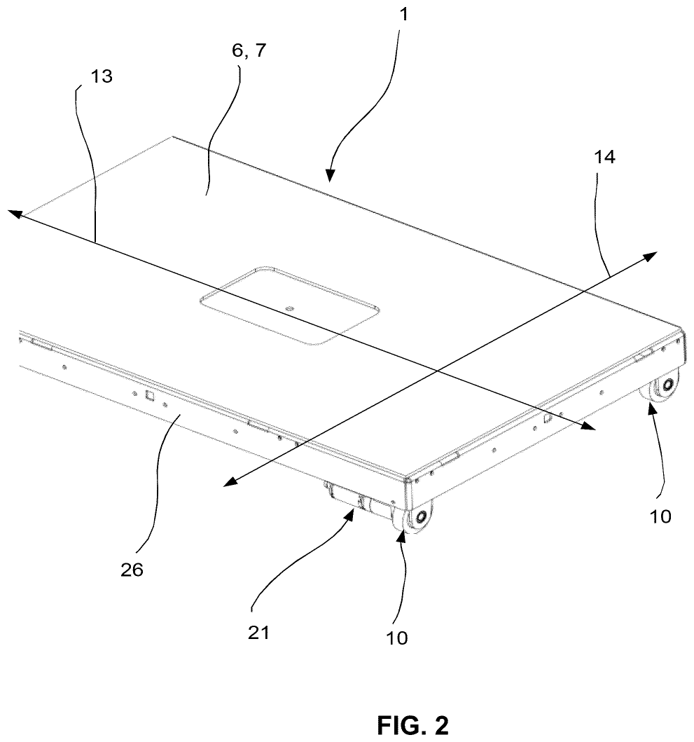

In the illustrated embodiment the wheels 9, 10 are divided into two groups, wherein the wheels 9 of a first group are jointly oriented so that the warehouse robot 1 is drivable in a first driving direction 13 on the ground 11 when the wheels 9 are driven to rotate. On the other hand side the wheels 10 of the second group are jointly oriented so that the warehouse robot 1 is drivable on the ground 11 in a second driving direction 14 by a rotation drive of the wheels 10. In the illustrated embodiment the warehouse robot 1 has a rectangular shape overall wherein in particular the loading surface 7 is configured rectangular. The two groups of wheels 9, 10 are oriented in the illustrated embodiment so that the first driving direction 13 is oriented parallel to a first main axis of the warehouse robot 1 and the second driving direction 14 is oriented perpendicular to the first driving direction 13 and parallel to a second main axis of the warehouse robot 1. The two driving directions 13, 14 jointly define a plane that is parallel to the loading surface 7. The orientation of the first main axis of the warehouse robot 1 corresponds to a long side of the rectangular loading surface 7, whereas the second main axis of the warehouse robot 1 is oriented perpendicular to the first main axis and parallel to a narrow side of the rectangular loading surface 7. This is evident in particular from FIG. 2.

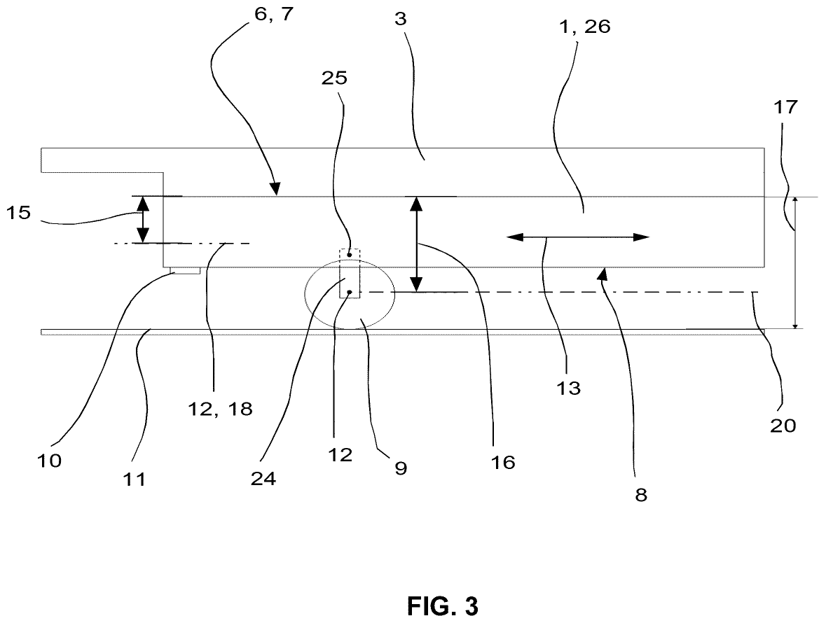

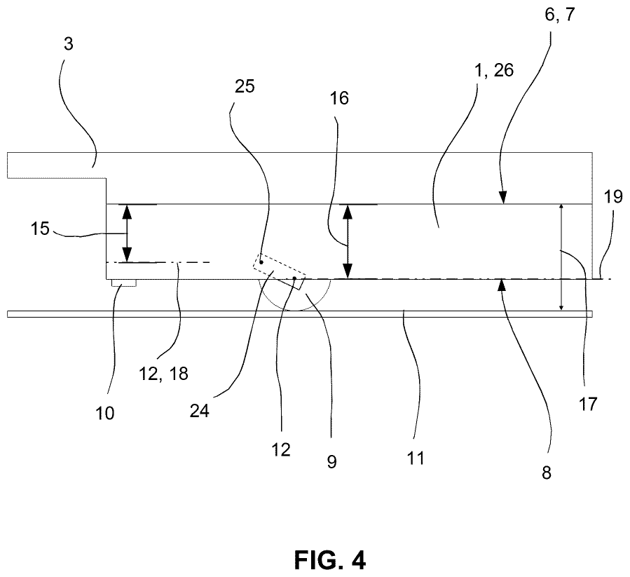

The wheels 9, 10 are alternatively provided in an active condition or in a passive condition during normal operation of the warehouse robot 1. Which wheels 9, 10 are provided in which condition is a function of a relative position of the wheels 9, 10 between each other. Therefore, the wheels 10 of a first group whose rotation axes 12 are at a distance 15 from the loading surface 7 measured perpendicular to the loading surface 7 are in their passive condition when the wheels 9 of the other group are at a distance 16 from the loading surface 7 also measured perpendicular to the loading surface 7 and the distance 16 of the wheels 9 is greater than the distance 15 of the wheels 10. Thus, the wheels 9 of the first group are therefore provided in their active condition. This means that the wheels 9 are in direct contact with the ground 11, so that the warehouse robot 1 is drivable on the ground 11 by driving the wheels 9 to rotate. The wheels 10 provided in the passive condition, however, have no contact with the ground 11. This is evident in particular from FIGS. 3-4.

It is furthermore evident from FIGS. 3-4 that the wheels 9, 10 can be provided in various positions relative to a housing 26 of the warehouse robot 1 in their active condition or passive condition. In the illustrated embodiment the wheels 9, 10 of both groups are respectively transitionable between their retracted position and two different extended positions. As stated supra the rotation axes 12 of all wheels are arranged in a common retraction plane 8 when they are respectively provided in their retracted position. By the same token, the first extension positions of the wheels 9, 10 are similar so that the rotation axes 12 of all wheels 9, 10 would be arranged in a common first extension plane 19 with all wheels 9, 10 in their first extension position. Furthermore, the rotation axes 12 of the wheels 9, 10 would be in a common second position plane with the wheels 9, 10 in their second extension position. When the wheels 10 of the first group are in their retracted position, the wheels 9 of the second group are always in their active condition when they assume one of the two extension positions. The retraction plane 8, the first extension plane 19 and the second extension plane 20 are oriented parallel to one another and parallel to the loading surface 7.

The two extension positions differ for all wheels 9, 10 in that the distance 16 of the rotation axis 12 of a respective wheel 9, 10 from the loading surface 7 is smaller when the wheels 9, 10 are in the first extension division, than when the wheels 9, 10 are in the second extension position. This is evident in particular when viewing FIGS. 3 and 4 together, wherein the wheels 9 of one group are in their second extension position in the situation illustrated in FIG. 3 and in their first extension position in the situation illustrated in FIG. 4. The wheels 10 of the other group are provided in their retracted position in both illustrated conditions.

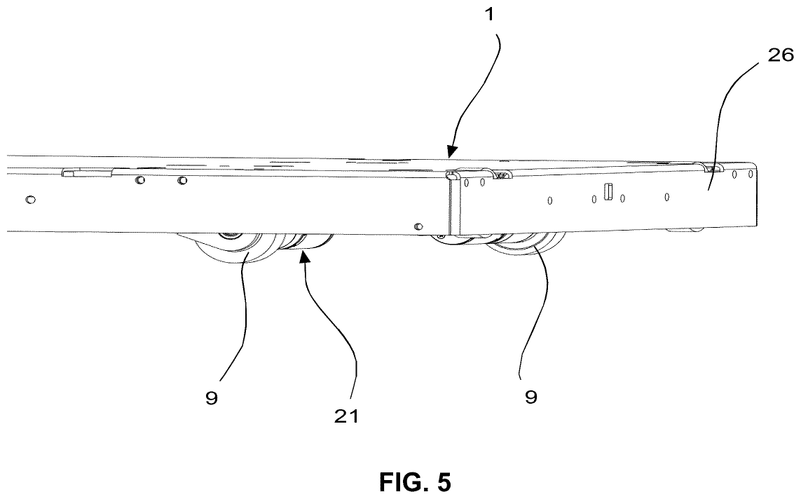

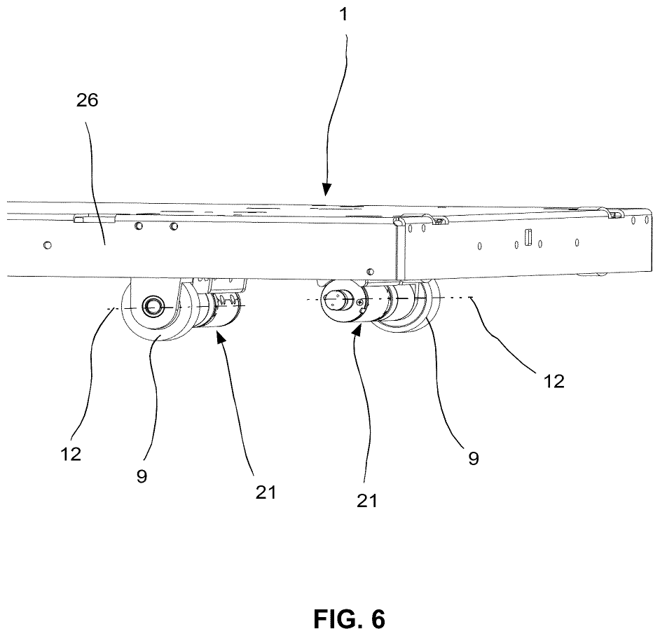

Transitioning the wheels 9, 10 from their first extended position into their second extended position coincides with transitioning the warehouse robot 1 from its unloading position into its loading position in the illustrated embodiment. Thus, it is evident from FIGS. 3 and 4 that an effective height 17 of the warehouse robot 1 that is measured from a lowest spot of a respective wheel 9, 10 or from the ground 11 orthogonal to the loading surface 7 up to the loading surface 7 is the greater, the further the wheels 9, 10 are extended in their active position. Since the wheels 9, 10 arranged in their second extended position are extended further than in the first extended position the effective height 17 of the warehouse robot 1 increases when the wheels 9, 10 transition from the first extended position into the second extended position. The extended positions are thus selected so that a difference between the effective heights 17 as a function of the extended position of the wheels 9, 10 has the effect that a distance between the ground 11 and a bottom side of a container 3 stored at a storage location 2 of the warehouse is being traveled when the wheels 9, 10 transition from their first extended position into the second extended position. Put differently, the loading surface 7 is raised far enough so that the warehouse robot 1 initially impacts the bottom side of the container and lifts the container from its storage location when the wheels 9, 10 move further. Thereafter the container 3 is supported on the loading surface 7 so that the warehouse robot 1 is in its loading position. The difference between the two extended positions of the wheels 9, 10 of the one group is clearly evident from FIGS. 5 and 6.

Therefore the warehouse robot 1 is configured so that the motors 4 that transition the wheels 9, 10 from their retracted position into their two extended positions are also used for receiving a respective container 3 from its storage location. Thus, the motors 4 perform double duty, namely determining a driving direction of the warehouse robot 1 transitioning the wheels 9, 10 between their active condition and their passive condition and transitioning the warehouse robot 1 between its unloading position and its loading position.

It is particularly advantageous for lifting a container 3 when all wheels 9, 10 of the warehouse robot 1 are moved so that they are synchronously transitioned into their respective second extended position. The warehouse robot 1 is initially positioned below a container 3 for this purpose and thereafter the wheels 10 of the first group are brought in contact with the ground 11 synchronously with the wheels 9 of the other group. Since the warehouse robot 1 is still arranged in its unloading position the wheels 9, 10 of both groups are accordingly provided in their first extended position in which the rotation axes 12 of all wheels 9, 10 are arranged in a common extension plane 19. Lifting the container 3 is now performed by synchronously transitioning all wheels 9, 10 into their second extended position wherein the torques of all motors 4 that respectively cause the movement of one of the wheels 9, 10 work in combination. Accordingly the wheels 9, 10 are synchronously transitioned into their second extended position and cause the warehouse robot 1 to transition into its loading position. A total lifting force imparted by the warehouse robot 1 that lifts the container 3 from its storage location is therefore provided by all motors 4 in combination. After receiving the container 3 the wheels 9, 10 of a respective group that is not required immediately for the warehouse robot 1 to travel are moved back into their retracted position.

In order for a driving direction of the warehouse robot 1 to change the wheels 9, 10 of both groups can be jointly moved into the first extension position or the second extension position depending on the warehouse robot 1 being loaded with a container 3 or not. Thus, the wheels 9, 10 of a first group are initially provided in their active condition, whereas the wheels 9, 10 of the second group are provided in their passive condition. The wheels 9, 10 of the second group are then moved into the same extended position where the wheels of the first group that is still active are arranged already. Thereafter all wheels 9, 10 are in contact with the ground 11 and are therefore all provided in their active condition. Then the wheels 9, 10 of the first group are retracted, advantageously into their retracted position so that they are provided in their passive condition. Thereafter only the wheels 9, 10 of the second group are provided in their active condition. Thus, the change of the driving direction has been performed. Thus, it is particularly advantageous when the effective height 17 of the warehouse robot 1 does not change during the process, this means the loading surface 7 remains at the same elevation continuously.

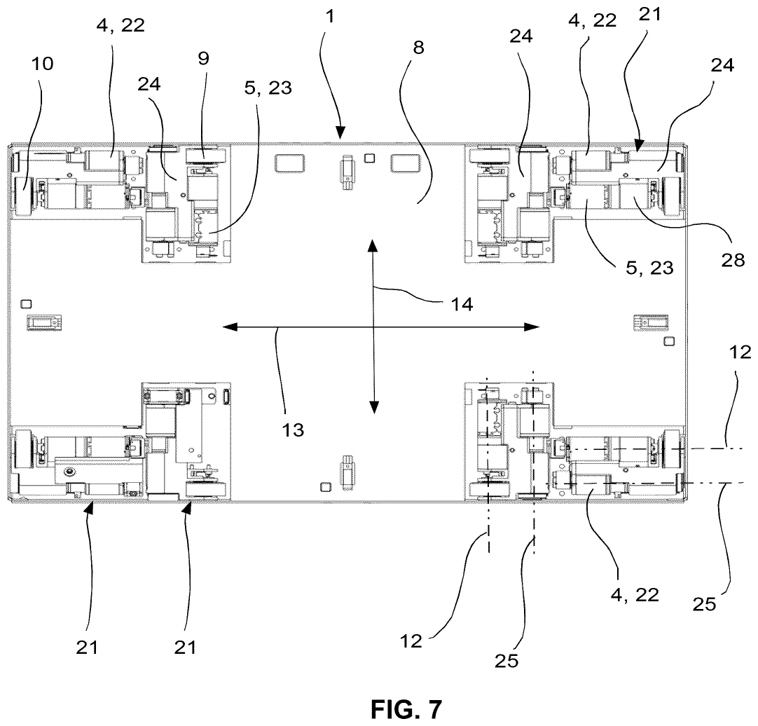

Advantageously each of the wheels 9, 10 of the illustrated warehouse robot 1 forms part of an operating unit 21. The operating units 21 are evident from FIGS. 7-9. Each operating unit 21 respectively includes a wheel 9, 10, a lift motor 22 formed by a motor 4, a drive motor 23 formed by a motor 5, a transmission 28 associated with the drive motor 23, and a pivot arm 24. The lift motor 22 is mounted torque proof at the housing 26 of the warehouse robot 1 by bearings 27. The lift motor 22 transfers torque through the pivot arm 24 which is pivotable about a pivot axis 25 relative to the housing 26 by operating a lift motor 22. The drive motor 23 is arranged at an end of the pivot arm 24 together with the downstream transmission 28, wherein the end of the pivot arm 24 is oriented away from the housing 26, so that pivoting the pivot arm 24 about the pivot axis 25 moves the drive motor 23 and the transmission 28 on a circular path about the pivot axis 24. The respective wheel 9, 10 is also arranged at an end of the pivot arm 24 that is oriented away from the housing 26.

Moving the pivot arm 24 about the pivot axis 25 causes a proportional movement of the wheel 9, 10 arranged at the pivot arm in a direction perpendicular to the loading surface 7. This is evident from FIGS. 3 and 4 showing the pivot arm 24 pivotable about the pivot axis 25 relative to the housing 26. Therefore, the operating unit 21 is configured to move the respectively associated wheel 9, 10 in the direction perpendicular to the loading surface 7 using the lift motor 22 and the operating unit 21 is also configured to drive the wheel 9, 10 to rotate about its rotation axis 12 using the drive motor 23. The operating unit 21 is configured so that the pivot axis 25 of the pivot arm 24 is oriented parallel to the rotation axis 12 of the respective wheel 9, 10. This way the operating unit is configured particularly compact which saves installation space.

### REFERENCE NUMERALS AND DESIGNATIONS

1 warehouse robot
2 storage location
3 container
4 motor
5 motor
6 topside
7 loading surface
8 bottom side
9 wheel
10 wheel
11 ground
12 rotation axis
13 driving direction
14 driving direction
15 distance
16 distance
17 height
18 retraction plane
19 extension plane
20 extension plane
21 operating unit
22 lift motor
23 drive motor
24 pivot arm
25 pivot axis
26 housing
27 bearing
28 transmission

What is claimed is:

1. A warehouse robot configured for automatically loading storage locations of a warehouse with containers, the warehouse robot comprising:
a plurality of electric motors;
a horizontally oriented loading surface arranged at a topside of the warehouse robot and configured to receive a container of the containers;
a plurality of motor rotatable wheels arranged at a bottom side of the warehouse robot and configured to move the warehouse robot on a ground,
wherein rotation axes of the wheels are respectively oriented parallel to the loading surface,
wherein first wheels of a first group of the wheels are synchronously oriented in a first driving direction, so that the warehouse robot is drivable in the first driving direction on the ground by motor driving the first wheels,
wherein second wheels of a second group of the wheels are synchronously oriented in a second driving direction that differs from the first driving direction so that the warehouse robot is drivable in the second driving direction on the ground by motor driving the second wheels,
wherein the first wheels of the first group and the second wheels of the second group are transferable into a passive condition and into an active condition,
wherein a distance measured orthogonal to the loading surface between rotation axes of the first wheels of the first group in their passive condition and the loading surface and between rotation axes of the second wheels of the second group in their passive condition and the loading surface is less than a distance measured orthogonal to the loading surface between the rotation axes of the first wheels of the first group in their active condition and the loading surface and between the second wheels of the second group in their active condition and the loading surface,
wherein the warehouse robot is transferable between a retracted unloading position and an extended loading position in an alternating manner,
wherein an effective height of the warehouse robot measured orthogonal to the loading surface is greater in the loading position, than in the unloading position,
wherein the first wheels of the first group and the second wheels of the second group are motor movable in a direction orthogonal to the loading surface between a retracted position and at least one extended position,
wherein a distance between a rotation axis of a respective first wheel of the first group and the loading surface measured orthogonal to the loading surface is greater for the respective first wheel of the first group in the extended position than for the respective first wheel of the first group in the retracted position, and a distance between a rotation axis of a respective second wheel of the second group and the loading surface measured orthogonal to the loading surface is greater for the respective second wheel of the second group in the extended position than for the respective second wheel of the second group in the retracted position,
wherein the wheels of at least one of the first group and the second group are motor movable into at least two extended positions where distances of the rotation axes of the first wheels of the first group from the loading surface measured orthogonal to the loading surface differ from distances of the rotation axes of the second wheels of the second group from the loading surface measured orthogonal to the loading surface,
wherein the warehouse robot is transitionable from a first extended position into a second extended position between its loading position and its unloading position by moving the first wheels of the first group or the second wheels of the second group, and
wherein the warehouse robot is operable so that all of the first wheels of the first group and all the second wheels of the second group are simultaneously provided in their active position, so that the distance between the rotation axes of all the first wheels and second wheels and the loading surface is identical for all the first wheels of the first group and all the second wheels of the second group.

2. The warehouse robot according to claim 1, wherein all the wheels of all the groups of the wheels are movable into at least two different extended positions or into exactly two extended positions.

3. The warehouse robot according to claim 1, wherein the rotation axes of all the wheels of all groups are arranged in a common retraction plane when all the wheels of all the groups are arranged in their retracted position.

4. The warehouse robot according to claim 1, wherein the rotation axes of all the wheels of all the groups are arranged in a common first extension plane when all the wheels of all the groups are arranged in their first extended position.

5. The warehouse robot according to claim 1, wherein the rotation axes of all the wheels of all the groups are arranged in a common second extension plane when all the wheels of all the groups are arranged in their second extended position.

6. The warehouse robot according to claim 1, wherein the first wheels of the first group or the second wheels of the second group are in their active condition and the warehouse robot is in its unloading position when the first wheels of the first group or the second wheels of the second group are in their first extended position.

7. The warehouse robot according to claim 1, wherein the first wheels of the first group or the second wheels of the second group are in their active condition and the warehouse robot is in its loading position when the first wheels of the first group or the second wheels of the second group are in their second extended position.

8. The warehouse robot according to claim 1,
wherein at least one first wheel of the first group or at least one second wheel of the second group, or at least one first wheel of the first group and at least one second wheel of the second group, or all wheels respectively form part of an operating unit, and
wherein a respective operating unit includes a lift motor configured to move the respective wheel between a retracted position and at least one extended position and a drive motor configured to drive the respective wheel to rotate about its rotation axis.

9. The warehouse robot according to claim 1,
wherein the wheels of at least one group of the first group and the second group, or the first wheels of the first group and the second wheels of the second group are respectively supported at a respective pivot arm, and
wherein the respective pivot arm is supported at a housing of the warehouse robot indirectly or directly pivotable about a pivot arm pivot axis.

10. The warehouse robot according to claim 9,
wherein a component axis of the pivot arm of a respective wheel is
oriented parallel to the loading surface when the pivot arm is in its retracted position, and/or
oriented at an angle between 20 degrees and 70 degrees relative to the loading surface when the respective wheel is in its first extended position, and/or
oriented at an angle between 80 degrees and 100 degrees relative to the loading surface when the respective wheel is in its second extended position.

11. The warehouse robot according to claim 8,
wherein the wheels of at least one group of the first group and the second group, or the first wheels of the first group and the second wheels of the second group are respectively supported at a respective pivot arm,
wherein the respective pivot arm is supported at a housing of the warehouse robot indirectly or directly pivotable about a pivot arm pivot axis,
wherein a lift motor is indirectly or directly supported at the housing,
wherein the lift motor is configured to pivot the pivot arm about the pivot arm pivot axis relative to the housing,
wherein the drive motor is supported at the pivot arm so that the drive motor is movable on a circular path about the pivot am pivot axis when transitioning the respective wheel between its retracted position and at least one extended position.

12. A method for operating a warehouse robot including:
a plurality of electric motors;
a horizontally oriented loading surface arranged at a topside of the warehouse robot and configured to receive a container of the containers;
a plurality of motor rotatable wheels arranged at a bottom side of the warehouse robot and configured to move the warehouse robot on a ground,
a wherein rotation axes of the wheels are respectively oriented parallel to the loading surface,
wherein first wheels of a first group of the wheels are synchronously oriented in a first driving direction, so that the warehouse robot is drivable in the first driving direction on the ground by motor driving the first wheels,
wherein second wheels of a second group of the wheels are synchronously oriented in a second driving direction that differs from the first driving direction so that the warehouse robot is drivable in the second driving direction on the ground by motor driving the second wheels,
wherein the first wheels of the first group and the second wheels of the second group are transferable into a passive condition and into an active condition,
wherein a distance measured orthogonal to the loading surface between rotation axes of the first wheels of the first group in their passive condition and the loading surface and between rotation axes of the second wheels of the second group in their passive condition and the loading surface is less than a distance measured orthogonal to the loading surface between the rotation axes of the first wheels of the first group in their active condition and the loading surface and between the second wheels of the second group in their active condition and the loading surface,
wherein the warehouse robot is transferable between a retracted unloading position and an extended loading position in an alternating manner,
wherein an effective height of the warehouse robot measured orthogonal to the loading surface is greater in the loading position, than in the unloading position, the method comprising:
a) driving the warehouse robot in the unloading position over a ground by motor driving the wheels of one of the groups and stopping the warehouse robot at a storage location loaded with a container so that the warehouse robot is stopped under the container;
b) moving the wheels of at least one group into an extended position by motor after stopping the warehouse robot below the container, so that the warehouse robot is transitioned from its unloading position into its loading position and retrieves the container from the storage location so that the container is supported on the loading surface of the warehouse robot thereafter;
c) driving the warehouse robot over the ground together with the container supported on the loading surface after receiving the container, wherein the driving is performed by motor driving the wheels of one of the groups; and
d) moving the wheels of the group whose wheels where in the passive condition by a motor into an extended position in which the wheels of both groups are in contact with the ground simultaneously in order to change the driving direction, wherein the wheels of the other group whose wheels were in their active condition are moved towards their retracted position and thus into their passive condition.

13. The method according to claim 12, wherein the wheels of the group whose wheels were in the active condition are moved into their retracted position and thus into their passive condition in order to change the driving direction.

14. The method according to claim 13, wherein the change of the driving direction is performed when the warehouse robot is in its unloading position and when the warehouse robot is in its loading position.

15. The method according claim 12, wherein the wheels of both groups are simultaneously transitioned into a common extension position where all wheels are in contact with the ground simultaneously for transitioning the warehouse robot into its loading position.
